(19) United States
(12) Patent Application Publication
(10) Pub. No.: US 2016/0037786 A1
(43) Pub. Date: Feb. 11, 2016

(54) METHOD FOR REDUCING MOLD IN LOWER WATER ACTIVITY BAKED FOOD PRODUCTS

(71) Applicant: INTERCONTINENTAL GREAT BRANDS LLC, East Hanover, NJ (US)

(72) Inventors: Renee M. GAN, Glenview, IL (US); Zuoxing ZHENG, Glenview, IL (US); Uraiwan TANGPRASERTCHAI, Glenview, IL (US); Bob E. DIAZ, East Hanover, NJ (US)

(73) Assignee: Intercontinental Great Brands LLC, East Hanover, NJ (US)

(21) Appl. No.: 14/775,135

(22) PCT Filed: Mar. 13, 2014
(86) PCT No.: PCT/US14/26825

§ 371 Date: Sep. 11, 2015

Related U.S. Application Data
(60) Provisional application No. 61/791,972, filed on Mar. 15, 2013.

(51) Int. Cl. A21D 15/08; A21D 8/04

(52) U.S. Cl. CPC A21D 15/08; A21D 8/047

(57) ABSTRACT

In an embodiment, disclosed herein are baked food products and methods of preparing a baked food product with extended mold-free shelf life, including baking a lower water activity baked food product, and applying live yeast to the baked food product, wherein the yeast comprises at least one of Zygosaccharomyces rouxii or Zygosaccharomyces bisporus.

### CROSS REFERENCE TO RELATED APPLICATION

This application claims the benefit of U.S. Provisional Application Ser. No. 61/791,972, filed Mar. 15, 2013, which is incorporated herein by reference in its entirety.

### BACKGROUND OF THE INVENTION

Mold is a common issue in many food products. Traditionally, chemical preservatives such as organic acids and salts have been added to baked goods to extend their shelf life. However, such additives may have several disadvantages such as undesirable taste, flavor, and/or smell, as well as an undesirable effect on the structure or texture of the baked good. As a result, a need exists for better, natural, cost-effective methods of preventing or reducing mold growth on baked goods.

### BRIEF SUMMARY OF THE INVENTION

According to some embodiments of the present invention, a process for preparing a baked food product with extended mold-free shelf life includes baking the baked food product, where the baked food product has a water activity of about 0.84 or less; and applying live yeast to the baked food product. In some embodiments, the yeast includes at least one of Zygosaccharomyces rouxii or Zygosaccharomyces bisporus.

The baked food product may show no visible mold growth for at least 1 month under non-refrigerated conditions after baking; or at least 3 months under non-refrigerated conditions after baking. In some embodiments, the baked food product contains no chemical preservatives.

The process may further include a step of preparing a solution of live yeast and a solvent. In some embodiments, the solution may include glucose broth. In certain embodiments, the solution includes yeast in an amount of about 1×10e6 cfu/ml to about 1×10e9 cfu/ml; or about 1×10e8 cfu/ml.

Yeast is applied to the baked food product by spraying the surface with a solution comprising the live yeast. The solution may be sprayed on the surface in an amount, for example, of about 0.1 ml/100 cm² to about 0.5 ml/100 cm².

In some embodiments, the baked food product has yeast in an amount of about 1×10e4 cfu/cm² to about 1×10e7 cfu/cm² on a surface of the baked food product; or about 2.5×10e5 cfu/cm² on a surface of the baked food product. The baked food product may have a water activity of about 0.6 to about 0.84.

According to some embodiments of the present invention, a baked food product with improved mold-free shelf life includes yeast in an amount of about 1×10e4 cfu/cm² to about 1×10e7 cfu/cm² on a surface of the baked food product, where the yeast includes at least one of Zygosaccharomyces rouxii or Zygosaccharomyces bisporus, and where the baked food product has a water activity of about 0.84 or less.

### DETAILED DESCRIPTION OF THE INVENTION

Methods and compositions of some embodiments of the present invention relate to preventing or reducing mold growth on baked food products having a lower water activity, as described in further detail in the sections below. It has been found that the application of certain yeasts to the surface of lower water activity baked food products prevents or reduces the growth of mold during the shelf life of the baked food product. Such yeasts may inhibit mold growth even in products without chemical preservatives, and without the use of refrigeration during storage of the baked food product.

In particular, surface application of osmophilic yeasts including Zygosaccharomyces rouxii (Z. rouxii) and/or Zygosaccharomyces bisporus (Z. bisporus) may inhibit mold growth on baked food products having a water activity of about 0.84 or less. It is believed that such yeasts thrive in lower water activity environments, producing naturally occurring volatiles which may inhibit the growth of mold. The ability to extend the shelf life of baked food products with a natural solution is a desired benefit for health-conscious consumers.

Product

The present invention provides a novel method for inhibiting the growth of molds in baked food products such as biscuits, cookies, bread, rolls, bagels, pizza crusts, tortillas, croissants, donuts, pita breads, cakes, and muffins. In particular, the present invention is effective for inhibiting or preventing mold growth on baked food products with lower water activity. The lower water activity may provide an environment suitable for the yeast described herein to thrive.

The methods of inhibiting the growth of molds in baked food products may include the treatment of a dough using a yeast described herein. A suitable dough may include a dough used in the preparation of baked food products such as biscuits, cookies, bread, rolls, bagels, pizza crusts, tortillas, croissants, donuts, pita breads, cakes, and muffins. In an embodiment, a dough is selected from the group of doughs used to prepare biscuits, cookies, bread, rolls, bagels, pizza crusts, tortillas, croissants, donuts, pita breads, cakes, or muffins. In another embodiment, a dough is selected from a dough or a dough component described in U.S. Pat. Appl. Pub. No. 2013/0101698, published Apr. 25, 2013, and hereby incorporated by reference in its entirety.

In some embodiments, a baked food product of the present invention has a water activity of about 0.84 or less; about 0.82 or less; about 0.80 or less; about 0.87 or less; about 0.76 or less; about 0.74 or less; about 0.72 or less; about 0.70 or less; about 0.68 or less; about 0.66 or less; about 0.64 or less; about 0.62 or less; about 0.60 or less; about 0.58 or less; about 0.56 or less; about 0.54 or less; about 0.52 or less; about 0.50 or less; about 0.48 or less; about 0.46 or less; about 0.44 or less; about 0.84; about 0.82; about 0.80; about 0.87; about 0.76; about 0.74; about 0.72; about 0.70; about 0.68; about 0.66; about 0.64; about 0.62; about 0.60; about 0.58; about 0.56; about 0.54; about 0.52; about 0.50; about 0.48; about 0.46; about 0.44; about 0.76 to about 0.84; about 0.6 to about 0.84; about 0.6 to about 0.88; about 0.40 to about 0.88; about 0.42 to about 0.88; or about 0.44 to about 0.84.

Baked food products of the present invention may be prepared in any suitable manner, and may contain any suitable ingredients, to provide a baked food product with a lower water activity. In some embodiments, the baked food product contains no chemical preservatives. In some embodiments, the baked food product contains chemical preservatives in addition to the yeast treatment of the present invention. In some embodiments, the baked food product contains a reduced amount of chemical preservatives as compared to the traditional baked food product without the yeast treatment of the present invention. Chemical preservatives may include, for example, propionates, sorbates, benzoates, parabens, and the like. In some embodiments, the baked food product contains no natural preservatives. In some embodiments, the baked food product contains natural preservatives in addition to the yeast treatment of the present invention. Natural preservatives may include, for example, plant extracts, spices, vinegar and the like.

Yeast

Methods of the present invention include the addition of live yeast to a food product after baking. The term “live yeast” refers to yeast that is capable of both anaerobic metabolism of sugars into alcohol and carbon dioxide gas and aerobic metabolism of sugars thereby consuming oxygen. Such live yeast cells can be enumerated as cfu (colony forming units) on petri dishes containing a yeast selective agar medium (YEP+chloroamphenicol).

Suitable yeast strains for the present invention include those that thrive in a lower water activity environment. In some embodiments, a suitable yeast includes one or more osmophilic yeasts such as Zygosaccharomyces rouxii and/or Zygosaccharomyces bisporus. One example of a suitable Z. rouxii yeast strain includes Z. rouxii Z64. In some embodiments this strain may be isolated from unpasteurized liquid sugar. It is believed that such yeasts thrive in lower water activity environments, producing naturally occurring volatiles which may inhibit the growth of mold on the baked food products of the present invention. Many naturally occurring volatiles, including acetaldehyde produced by yeast from ethanol in the presence of oxygen, are known to have antifungal and antibacterial properties, and therefore may be effective for inhibiting the growth of decay microorganisms including molds. Methods and compositions of the present invention are useful as they provide a slow release system to continuously generate acetaldehyde, thereby preventing mold over an extended product shelf life.

Process

The live yeast cells of the present invention may be added to the baked food product in any suitable manner. In some embodiments, live yeast cells may be applied by brushing or spraying a solution containing live yeast onto the surface of a baked food product. In other embodiments, a live yeast solution may be injected into the baked food product, or sprayed onto the packaging that comes into contact with the surface of the baked good after packaging.

A solution containing live yeast cells may be prepared with any suitable ingredients. A solution may generally be prepared by combining live yeast cells with a solvent. Suitable solvents may include but are not limited to water, glucose broth, saline, yeast and mold broth, and combinations thereof. In some embodiments, for example, the yeast is incubated in a dextrose glucose broth for a selected period of time prior to application of the yeast to the baked good (for example, by spraying the yeast on the baked good). The selected incubation period may be from about 24 hours to about 48 hours, from about 12 hours to about 60 hours, from about 6 hours to about 168 hours (e.g., 1 week). In some embodiments, the yeast is incubated in accordance with the methods disclosed in U.S. Pat. Appl. Pub. No. 2012/0156326 published on Jun. 21, 2012 and hereby incorporated by reference in its entirety herein. In some embodiments, the solution may include additional suitable ingredients to provide a live yeast solution in the form of an egg wash or icing. In some embodiments, live yeast may be incorporated in the baked food product in the form of a cream, jelly, or filling. Yeast may be included in the live yeast solution on an amount of about 1×10e5 cfu/ml to about 1×10e10 cfu/ml; about 1×10e6 cfu/ml to about 1×10e9 cfu/ml; about 1×10e7 cfu/ml to about 1×10e8 cfu/ml; about 1×10e5 cfu/ml; about 1×10e6 cfu/ml; about 1×10e7 cfu/ml; about 1×10e8 cfu/ml; about 1×10e9 cfu/ml; or about 1×10e10 cfu/ml.

It is important for mold-inhibition of the present invention that the yeast is alive at the time of application and remains alive after application to the baked food product. Yeast may be most stable at refrigerated temperatures and may be rapidly inactivated at temperatures above about 125° F. As a result, in some embodiments the live yeast solution may be kept refrigerated and applied to a baked food product that is not too hot, such as at ambient conditions.

In some embodiments, a refrigerated live yeast solution is sprayed on the surface of a baked food product in an amount of about 0.05 ml/100 cm² to about 1 ml/100 cm²; about 0.1 ml/100 cm² to about 0.5 ml/100 cm²; about 0.2 ml/100 cm² to about 0.4 ml/100 cm²; about 0.05 ml/100 cm²; about 0.1 ml/100 cm²; about 0.2 ml/100 cm²; about 0.25 ml/100 cm²; about 0.3 ml/100 cm²; about 0.4 ml/100 cm²; about 0.5 ml/100 cm²; about 0.75 ml/100 cm²; or about 1 ml/100 cm². In some embodiments, the yeast solution is applied to the surface of the baked food product to provide yeast on the surface of the baked food product in an amount of about 1×10e3 cfu/cm² to about 1×10e8 cfu/cm²; about 1×10e4 cfu/cm² to about 1×10e7 cfu/cm²; about 1×10e5 cfu/cm² to about 1×10e6 cfu/cm²; about 1×10e3 cfu/cm²; about 1×10e4 cfu/cm²; about 1×10e5 cfu/cm²; about 2.5×10e5 cfu/cm²; about 1×10e6 cfu/cm²; about 1×10e7 cfu/cm²; or about 1×10e8 cfu/cm².

Live yeast solution may be applied to a baked food product using conventional spray equipment. For example, the spraying equipment may include a pump to transfer the yeast solution to spraying nozzles and an air compressor to finely disperse the yeast solution when it passes through the nozzles. The nozzles may be mounted on a spraying bar and can be adjusted in direction, volume, etc. to obtain the desired spraying pattern.

After application of the live yeast to the baked food product, the baked food product may be packaged and/or stored. In some embodiments, the baked food product may be packaged and/or stored at ambient conditions. The term “ambient conditions” refers to the temperature and pressure of the surrounding in which the baked food products are kept for distribution and storage by the producer, distributor, and/or consumer, which in most cases is room temperature. In some embodiments, the baked food products may be packaged in a suitable packing such as a plastic bag, foil package, coated paper bag, or other impermeable or semi-permeable bags.

Mold Prevention

It has been found that application of the yeast of the present invention to the surface of lower water activity baked food products results in inhibited mold growth during the shelf life of the baked food product. Mold inhibition may be present even in the absence of refrigerated conditions and/or the absence or reduction of chemical preservatives.

As discussed above, yeast strains of the present invention thrive in a lower water activity environment, producing naturally occurring volatiles which may inhibit the growth of mold on the lower water activity baked food products of the present invention. Some methods and compositions of the present invention are useful as they provide a slow release system to continuously generate acetaldehyde, thereby preventing mold growth over an extended product shelf life. In some embodiments, a baked food product includes acetaldehyde present at levels in sufficient amounts to prevent mold over an extended product shelf life.

In some embodiments, a baked food product that has been subjected to one or more of the methods described herein (e.g., that has a mold-retarding substance incorporated therein or incorporates a surface treatment of a mold-retarding substance) shows no visible mold growth for at least 1 month after baking; at least 2 months after baking; at least 3 months after baking; at least 4 months after baking; at least 5 months after baking; about least 6 months after baking; at least 8 months after baking; at least 10 months after baking; at least 12 months after baking; at least 18 months after baking; or at least 24 months after baking.

In some embodiments, a baked food product that has been subjected to one or more of the methods described herein (e.g., that has a mold-retarding substance incorporated therein or incorporates a surface treatment of a mold-retarding substance) shows no visible growth of a xerophilic mold. In some embodiments, a baked food product shows no visible growth of a xerophilic mold that is a mold found in food products. In some embodiments, a baked food product shows no visible growth of a xerophilic mold selected from the group consisting of an Eurotium species such as E. amstelodami, an Aspergillus species such as A. penicillioides, a Wallemia species such as W. sebi, a Chrysosporium species such as C. xerophilum Pitt, C. inops (Carmichael), or C. farinicola (Burnside) Skou, a Xeromyces species such as X. bisporus, a Polypaecilum species, an Eremascus species, a Basipetospora species, or a combination of any of the foregoing.

The following examples, wherein all parts, percentages, and ratios are by weight, and all temperatures are in ° F. unless indicated to the contrary, illustrate some embodiments of the present invention:

### EXAMPLES

### Example 1

An example of a suitable baked food product for use with the yeast application of the present invention is demonstrated by the formulation below:

| Ingredients | % |
|---|---|
| flour | 52.12 |
| Sugar | 7.00 |
| Salt | 1.05 |
| Hydrocolloids | 1.31 |
| preservatives | 0.23 |
| dough conditioner | 1.60 |
| yeast | 0.81 |
| Enzymes | 1.85 |
| Flavor | 0.01 |
| Water | 21.52 |
| Oil | 8.00 |
| Glycerin | 3.80 |
| Lecithin | 0.70 |
| Total | 100.00 |

The water activity of this baked food product is about 0.76.

### Example 2

A total of 24 samples were prepared. Three types of bread were baked: 1) regular preservative level; 2) reduced preservative level; 3) no preservatives. All three types of bread had a water activity of 0.75. The preservatives included calcium-propionate and encapsulated sorbic acid. Samples of each type of bread were then subjected to different surface treatments: 1) sprayed with water (control); 2) sprayed with about 0.2 ml freshly grown Z. rouxii in yeast mold broth in an amount of about 0.25 ml/100 cm²; 3) sprayed with about 0.2 ml freshly grown Z. bisporus in yeast mold broth in an amount of about 0.25 ml/100 cm²; 4) sprayed with about 0.2 ml Baker's yeast in yeast mold broth in an amount of about 0.25 ml/100 cm². Finally, samples were either left as is, or were inoculated with about 3 log CFU/bread mold spore cocktail (A. niger, E. repens “BG” and “Y”, P. species, E. rubrum “10”, E. herbariorum, a puree isolate, an apricot isolate).

The samples were then stored and monitored for visible mold growth. The following chart shows the time before any visible mold growth for each sample, where “Inoc” refers to inoculated samples and “Un-Inoc” refers to samples left as is:

| | Time to Visible Mold Growth (days) | | | | | |
|---|---|---|---|---|---|---|
| | Regular | | Reduced | | No | |
| | Preservatives | | Preservatives | | Preservatives | |
| Treatment | Un-inoc | Inoc | Un-Inoc | Inoc | Un-Inoc | Inoc |
| Water | No | No | No | 74 | 56 | 28 |
| | growth | growth | growth | | | |
| Z. rouxii | No | No | No | No | No | No |
| | growth | growth | growth | growth | growth | growth |
| Z. bisporus | No | No | No | No | No | 49 |
| | growth | growth | growth | growth | growth | |
| Baker's | No | No | No | 56 | 49 | 53 |
| Yeast | growth | growth | growth | | | |

Based on the inoculated treatment, as demonstrated in the results above, the product without preservatives showed mold growth after 4 weeks in control. Z. bisporus and Baker's Yeast (which is not an osmophilic yeast) delayed mold growth by about 3 weeks, while Z. rouxii prevented mold growth. With reduced preservatives, mold growth appeared after 8-10 weeks in control and Gold Yeast while Z. rouxii and Z. bisporus prevented mold growth. “Regular” preservative levels prevented mold growth in all samples.

In conclusion, the osmophilic yeast was successful for mold growth prevention on lower water activity baked food for at least six months. Z. rouxii provided the best protection against mold, and achieved the same level of inhibition as regular preservative levels.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention.

We claim:

1. A process for preparing a baked food product with extended mold-free shelf life, comprising:
(a) baking the baked food product, wherein the baked food product has a water activity of about 0.8 or less;
(b) applying live yeast to the baked food product, wherein the yeast comprises at least one of Zygosaccharomyces rouxii or Zygosaccharomyces bisporus.

2. The process of claim 1, wherein the baked food product shows no visible mold growth for at least 1 month under non-refrigerated conditions after baking.

3. The process of claim 1, wherein the baked food product shows no visible mold growth for at least 3 months under non-refrigerated conditions after baking.

4. The process of claim 1, wherein the baked food product contains no chemical preservatives.

5. The process of claim 1, wherein the applying step includes spraying a surface of the baked food product with a solution comprising the live yeast.

6. The process of claim 5, wherein the solution further comprises glucose broth.

7. The process of claim 1, further comprising preparing a solution comprising the live yeast and a solvent.

8. The process of claim 7, wherein the solution includes yeast in an amount of about 1×10e6 cfu/ml to about 1×10e9 cfu/ml.

9. The process of claim 7, wherein the solution includes yeast in an amount of about 1×10e8 cfu/ml.

10. The process of claim 1, wherein the baked food product has yeast in an amount of about 1×10e4 cfu/cm² to about 1×10e7 cfu/cm² on a surface of the baked food product.

11. The process of claim 1, wherein the baked food product has yeast in an amount of about 2.5×10e5 cfu/cm² on a surface of the baked food product.

12. The process of claim 5, wherein the solution is sprayed on the surface in an amount of about 0.1 ml/100 cm² to about 0.5 ml/100 cm².

13. The process of claim 1, wherein the baked food product has a water activity of about 0.6 to about 0.846.

14. A baked food product with improved mold-free shelf life comprising yeast in an amount of about 1×10e4 cfu/cm² to about 1×10e7 cfu/cm² on a surface of the baked food product,
wherein the yeast comprises at least one of Zygosaccharomyces rouxii or Zygosaccharomyces bisporus; and
wherein the baked food product has a water activity of about 0.86 or less.

15. The baked food product of claim 14, wherein the yeast is present on the surface in an amount of about 2.5×10e5 cfu/cm².

16. The baked food product of claim 14, having a water activity of about 0.6 to about 0.86.

17. The baked food product of claim 14, having a water activity of about 0.76 or less.

18. The baked food product of claim 14, wherein the baked food product shows no visible mold growth for at least 1 month under non-refrigerated conditions after baking.

19. The baked food product of claim 14, wherein the baked food product shows no visible mold growth for at least 3 months under non-refrigerated conditions after baking.

20. The baked food product of claim 14, wherein the baked food product contains no chemical preservatives.

21. The baked food product of claims 1 and 14 wherein the baked food product contains no natural preservatives.
